(19) United States
(12) Patent Application Publication
(10) Pub. No.: US 2009/0107921 A1
(43) Pub. Date: Apr. 30, 2009

(54) Chemical treatment system and method

(75) Inventors: Yu-Gene T. Chen, Glendale, AZ (US); Ron Dinello, Phoenix, AZ (US)

Correspondence Address: Honeywell International Inc.;Patent Services Department, 101 Columbia Road, Morristown, NJ, 07962, US

(73) Assignee: Honeywell International Inc.

(21) Appl. No.: 11/977,881

(22) Filed: Oct. 26, 2007

(51) Int. Cl. C02F 5/08; B01F 15/02; C23F 11/00; G05D 21/00

(52) U.S. Cl. 210/739; 700/266; 210/97; 210/103; 210/696; 210/742; 210/741; 210/90; 210/91; 210/86; 210/198.1

(57) ABSTRACT

A chemical treatment system that injects one or more dosage chemical solutions into a process. Conditions of the process are sensed by sensors, communicated to a chemical treatment management system. The chemical treatment management system processes the process conditions and issues command signals to one or more chemical storage systems to provide a dosage of chemical to the process. The chemical storage systems each comprise a chemical storage tank, a level sensor for the tank, a controller and a pump. The controller uses the command signals for varying in real time the dosage of the chemical solution by varying the pump operation. The chemical treatment management system also uses additional data from the chemical storage systems, such as tank level, and from other sources to provide the command signals and alerts/alarms and other user information.

### RELATED APPLICATION

This application is related to commonly assigned U.S. application Ser. No. ______, filed concurrently herewith, Attorney Docket No. 0011831-103.

### FIELD OF THE INVENTION

This invention relates to a system and method for chemical treatment of a process.

### BACKGROUND OF THE INVENTION

Chemical treatment management systems are used in chemical and refinery plants for major operational areas such as process units, cooling water systems, steam generating systems and wastewater systems and other systems. The chemical treatments are used for corrosion and scale control (corrosion and scale inhibiting chemicals), bio-control (biocides and disinfectants), pH control (pH adjusters), foaming control (anti-foaming and defoamers), emulsion control (emulsion breakers), solids control (coagulants and flocculants) and others.

Most chemical treatment systems are small stand-alone systems monitored by outside operators. These systems are often neglected by operators and are looked after by the chemical treatment vendor on a periodic basis. FIG. 1 shows a process 20 that receives chemical treatment from a typical chemical injection system 30. System 30 includes a skid-mounted chemical storage tank or drum 32 with a fill line 34, a drain line 36 and a sight glass 38 for visual inspection of drum inventory. The drum inventory contains a solution of the chemicals for the treatment of process 20. A chemical injection pump 40 with a calibration tube 42 pumps a desired treatment dosage from drum 32 via an injection valve 44 for insertion into process 20. System 30 is operated almost entirely manually making it prone to operator error and neglect. Significant incidents have been reported such as inadvertent discharge of the entire drum inventory to the process sewer or cooling tower basin, excess dosage to process 20 that caused high chemical concentrations in process water draws. All of these incidents resulted in additional costs and harm to the plant's wastewater treatment system.

Low inventory can cause the loss of treatment with its associated cost in terms of increased corrosion, reduced throughput caused by foaming, etc. Expedited delivery of additional chemicals can add substantially to the cost of chemical treatment. High inventories typically indicate the loss of dosing over time.

There is a need for a chemical treatment system and method for a process that overcome the above mentioned problems.

There is a need for a chemical treatment system and method that overcome the above mentioned problems for the control of corrosion and scale.

### SUMMARY OF THE INVENTION

A chemical treatment system of the present invention injects a chemical solution into a process for corrective action of a condition of the process. The chemical treatment system comprises a chemical storage system that comprises a chemical storage tank containing a chemical solution and a chemical treatment management system that receives notice of the condition and provides a command for the corrective action to the chemical storage system that responds to provide a dosage of the chemical solution to the process.

In one embodiment of the chemical treatment system of the present invention, the condition comprises one or more variables of corrosion.

In another embodiment of the chemical treatment system of the present invention, the chemical treatment management system receives the notice and sends the command via wireless communication.

In another embodiment of the chemical treatment system of the present invention, the chemical treatment management system receives a notice of a level of the chemical solution in the chemical storage tank and provides an alert output when the level is unexpectedly low.

In another embodiment of the chemical treatment system of the present invention, the condition is a first condition of a plurality of conditions associated with the process. The chemical treatment management system determines the dosage based additionally on a second condition of the plurality of conditions.

In another embodiment of the chemical treatment system of the present invention, the second condition is a member of the group consisting of: operating settings of the process, process environmental conditions, production rates, raw material cost, product quality measures, rejection rates, chemical indicators, other user chosen key process indicators and any combination thereof.

In another embodiment of the chemical treatment system of the present invention, the condition is a member of the group consisting of: corrosion, flow, pressure, temperature, pH, and other inputs for prediction of effects on corrosion, pitting, foaming, and other process environmental conditions.

In another embodiment of the chemical treatment system of the present invention, the notice of the condition is received by both the chemical storage system and the chemical treatment management system. The chemical treatment management system determines whether the command is provided to the chemical storage system. If the command is not provided, the chemical storage system responds to the notice to provide the dosage of the chemical solution to the process.

In another embodiment of the chemical treatment system of the present invention, the chemical treatment management system produces as outputs one or more of the following items:
a report on usage and effectiveness of the chemical solution on the process and/or the condition,
a graph of chemical treatment agent vs. the condition, and/or production quality, and or cost of production, and/or other key process indicators,
an alert/alarm to the process control system to alert process operators of pitting events or high corrosion events, or impending corrosion events that require operator intervention,
an order or order request for chemical agents to be re-ordered for the chemical solution,
a determination of the best chemical to use for treating the condition of the process based on financial indicators and/or environmental impact factors as well as available inventory of chemicals,
a determination of a best recommended course of action for alerts/alarms to the operator of the process based on environmental factors, or
a recommended course of action based on an inferred event of the process and a best corrective action based on available treatment chemicals.

In another embodiment of the chemical treatment system of the present invention, the alert/alarm comprises a notification of the existence of a leak in the chemical storage tank.

In another embodiment of the chemical treatment system of the present invention, the chemical storage system is a first chemical storage system. A second chemical storage system is provided that also comprises a chemical tank containing a chemical solution. The chemical treatment management system selectively enables the first and second chemical storage systems to provide dosages of their respective chemical solutions to the process.

In another embodiment of the chemical treatment system of the present invention, the chemical solution of the second chemical storage system also treats the condition or treats another condition of the process.

In another embodiment of the chemical treatment system of the present invention, the chemical treatment management system comprises a processing module and a process control system that receives the notice of the condition and transmits the command to the chemical storage system. The processing module determines the dosage of the chemical solution based on the notice for inclusion in the command.

In another embodiment of the chemical treatment system of the present invention, the processing module comprises a program that determines the command.

In another embodiment of the chemical treatment system of the present invention, the program determines the command based on a plurality of conditions.

A method of the present invention injects a chemical solution into a process for corrective action of a condition of the process. The method comprises providing a dosage of the chemical solution to the process, and controlling the providing step with a chemical treatment management system based on a notification of the condition and at least one other condition associated with the process.

In one embodiment of the method of the present invention, the condition comprises one or more variables of corrosion.

In another embodiment of the method of the present invention, the condition is a first condition of a plurality of conditions associated with the process. The chemical treatment management system determines the dosage based additionally on a second condition of the plurality of conditions.

In another embodiment of the method of the present invention, the chemical solution is a first chemical solution that is contained in a first chemical storage tank. A second chemical solution is contained in a second chemical storage tank. The chemical treatment management system selectively controls providing dosages of the first and second chemical solutions from the first and second chemical storage tanks, respectively, to the process for the corrective action.

In another embodiment of the method of the present invention, the chemical solution of the second chemical storage system also treats the condition or treats another condition of the process.

In another embodiment of the method of the present invention, the chemical solution is contained in a chemical storage tank. The chemical treatment management system receives a notice of a level of the chemical solution in the chemical storage tank and provides an alert output when the level is unexpectedly low.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a diagram of a prior art chemical treatment system;

FIG. 2 is a diagram of a chemical treatment system of the aforementioned related application;

FIG. 3 is a graph that depicts corrosion rate as a function of treatment dosage for the chemical treatment system of FIG. 2;

FIG. 4 is diagram of a chemical treatment system of the present invention;

FIG. 5 is a block diagram of the chemical treatment management system of the chemical treatment system of FIG. 4; and

FIG. 6 is flow diagram of a procedure that is executed by the chemical treatment management system of FIG. 5.

### DESCRIPTION OF THE PREFERRED EMBODIMENT

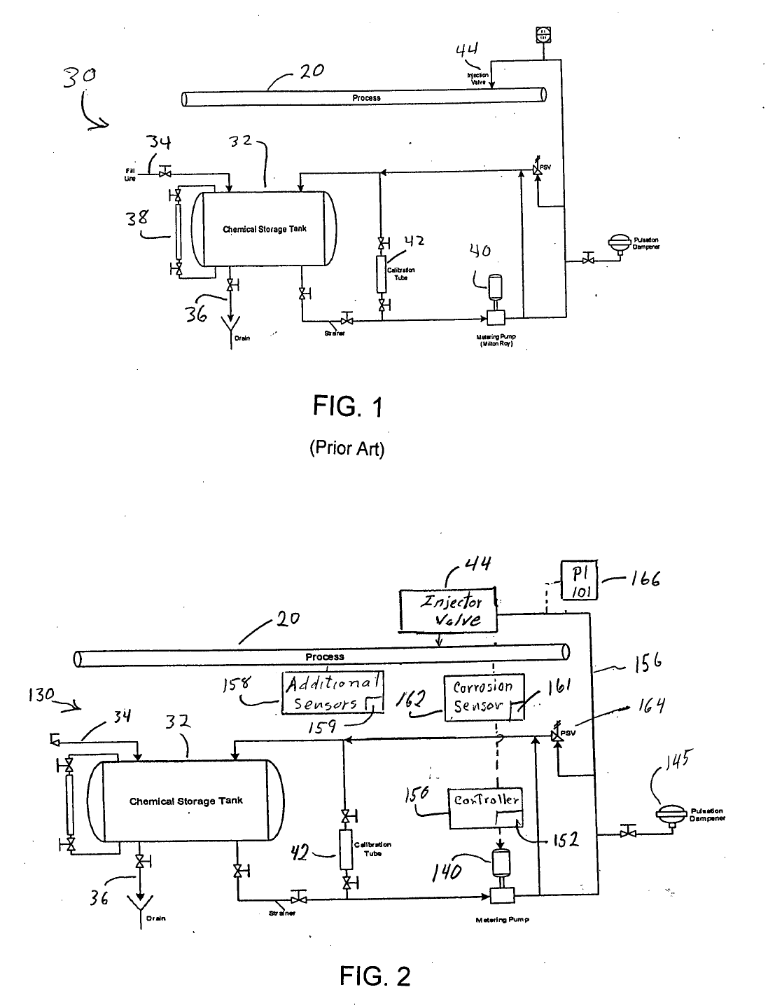

Referring to FIG. 2, a chemical treatment system 130 is disposed to control chemical treatment of a process 20. Chemical treatment system 130 includes components that are the same as components included in FIG. 1 and that bear like reference numerals.

Chemical treatment system 130 comprises a vessel, shown as a skid-mounted drum 32 with a fill line 34, a drain line 36, a calibration tube 42 and a sight glass 38 for visual inspection of drum inventory. In a preferred embodiment a corrosion inhibitor is supplied to drum 34 via fill line 34. The corrosion inhibitor may vary from one process to another.

Chemical treatment system 130 further comprises a corrosion sensor 162 disposed to sense corrosion and/or scaling in process 20 and to supply an output signal that is a function of the corrosion rate. Corrosion sensor 162 may be any suitable corrosion sensor. For example, corrosion sensor 162 may be a SmartCet™ probe, SmartCet™ being a trademark of Honeywell International, Inc.

Chemical treatment system 130 further comprises a chemical injection pump 140 and a controller 150 that are connected in a closed loop with corrosion sensor 162 to control dosage injection of the chemical inhibitor into process 20. Controller 150 may be any suitable controller. Controller 150, for example, may be a Profit Controller® device, or Profit Loop™ controller available from Honeywell International Inc. Profit Controller is a registered trademark of and Profit Loop is a trademark of Honeywell International Inc.

Chemical injection pump 140 is a variable speed pump having a variable speed drive that is controlled automatically by controller 150 to pump a desired dosage of the corrosion inhibitor via a line 156 and an injection valve 44 for insertion into process 20. For example, the corrosion inhibitor is injected into a wastewater system (not shown) in process 20. That is, the desired dosage is a flow rate that is determined by the speed of chemical injection pump 140.

Chemical treatment system 130 further comprises a pulsation dampener 145, an over pressure protection valve 164 and a pressure indicator 166, each being coupled to line 156. Pulsation dampener 145 dampens pulsation from chemical injection pump 145.

Corrosion sensor 162, for example, provides an output signal that is proportional to a corrosion rate that occurs to an element (e.g., a vessel, a pipe, etc.) in process 20. Controller 150 uses the output signal from corrosion sensor 162 to generate an output or dosage control signal that controls the speed of chemical injection pump 140. For some pumps, the controller output signal is a 4 to 20 milli-amperes current pulse signal. For other pumps, the output signal may differ. Thus, chemical storage tank or drum 32, chemical injection pump 140, injector valve 44, process 20, corrosion sensor 162 and controller 150 are disposed in a closed loop control to meter the chemical inhibitor solution from chemical storage tank 32 to process 20 in a dosage flow rate based on the corrosion rate detected by corrosion sensor 162. Controller 150 correlates or compares the current value of the corrosion signal with its value at a previous correlation time. If greater, the dosage is increased by increasing the pump speed. If less, the dosage is decreased by decreasing the pump speed. If there is no change, the current pump speed is maintained.

Corrosion sensor 162 could also, or alternatively, provide an output signal that is proportional to pitting of a surface of an element in process 20. Since pitting is indicative of an advanced state of corrosion, controller 150 may be programmed to respond to the pitting signal to change the pump speed by larger increments. For example, if a normal incremental speed change of X is made in response to the corrosion signal, then in response to the pitting signal the speed change increment is larger by as much as 10× or more.

Corrosion sensor 162 can also provide an output B-value, known as the Stern Geary Constant. The B-value may optionally be used by controller 150 as a disturbance variable to adjust the dosage of the chemical solution (and/or pressure, temperature, flow) by fine adjustment of the speed of chemical injection pump 140, thereby controlling the output or conditions of process 20 to reduce corrosion rate, pH, and/or overall cost per unit of the product of process 20.

Chemical injection pump 140 may be any variable speed pump, such as any off-shelf injection pump that is controllable by an input signal to vary pump speed or flow rate. The pump size, impeller and manufacturer may vary from process to process as well as the chemical being injected. Alternatively, chemical injection pump 140 may simply be a manual metering pump with its micrometer screw adjustment replaced by an electronic actuator that would be controlled by controller 150. This would allow automatic flow rate adjustment in response to an output signal from controller 150.

Corrosion sensor 162 preferably has a wireless transmitter 161 that transmits its output signal(s) to controller 150. Controller 150 has a wireless transceiver that receives the transmitted signals from wireless transmitter 161. Alternatively wireless transmitter 161 and/or wireless transceiver 152 can be independent units that are in wired communication with corrosion sensor 162 and controller 150, respectively. The wireless communication between corrosion sensor 162 and controller 150 together with the closed loop control provide a real time control as distinguished from the manually controlled system described in the Background of the Invention.

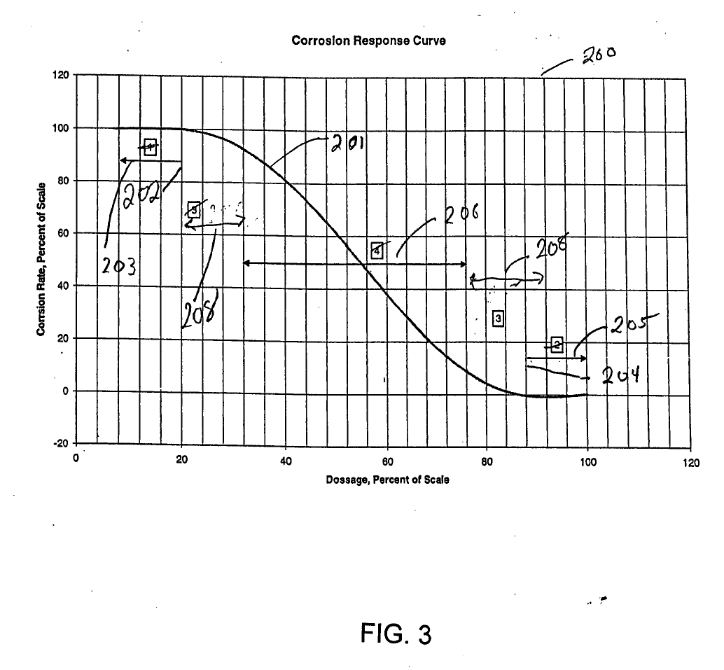

Referring to FIG. 3, a graph 200 depicts a curve 201 of corrosion rate as a function of corrosion inhibitor dosage. Curve 201 comprises a linear region or range 206 subtended by non-linear ranges 203 and 205. A dosage 202 is a minimum dosage, less than which no reduction in corrosion rate occurs. A dosage 204 is a maximum dosage, greater than which no reduction in corrosion rate occurs. Between dosages 202 and 204 is controllable region or range 206 that is reasonably linear with dosage rate. Regions 208 are transition regions. Controller 150 performs a correlation that allows dosages in the controllable or linear range 206 as well as in the non-linear ranges 203 and 205.

The objective of closed loop control is to maintain the measured corrosion rate at a specified value or within a range. If the corrosion rate is specified as a range (for example, range 206), then an economic objective function can be formulated as a minimum cost function as shown by the following equation:

Cost_{T}+COR*Cost_{COR}+INH*Cost_{INH}

### Where:

Cost_{T} is the total cost, USDollars/Time
COR is the corrosion rate, Length/Time
Cost_{COR} is the cost of corrosion, USDollars/Length
INH is the inhibitor rate, Volume/Time
Cost_{INH} is the cost of the inhibitor, USDollars/Volume

The economic objective serves to optimize inhibitor dosage rate by minimizing corrosion rate and minimizing total cost. There is a trade off the cost of the inhibitor against the equipment life. The tendency is for the objective function to maximize dosage in order to minimize corrosion rate. On the other hand, when corrosion is in a stage in which pitting occurs, the pitting signal output of corrosion sensor 162 may be used to provide a large dosage increase as compared to a normal dosage increase.

Additional sensors 158 of other functionalities may optionally be provided to monitor other conditions of process 20. An output signal from one of the additional sensors 158 can be used in combination with or in place of the output signal of corrosion sensor 162 as an input to controller 150. If controller 150 has multiple inputs, the output signals of additional sensors 158 and corrosion sensor 162 can be used in any desired combination to produce the signal that controls the pump speed. Additional sensors 158 preferably include wireless transmitters 159 to transmit their output signals to controller 150.

Additional sensors 158 may sense other conditions of process 20. For example, in a wastewater system these conditions may include process measurements such as flow rate of the wastewater, temperature, and pressure (e.g., pressure in the tanks, piping and other pressure vessels that make up the process system). Other sensed conditions may include pH, biocide concentration, oxygen scavenger concentration and others.

Calibration of pump 140 can be performed by hand or with a tool. The calibration results can be entered into controller 150 by any suitable input device, such as a handheld device with wired or wireless communication.

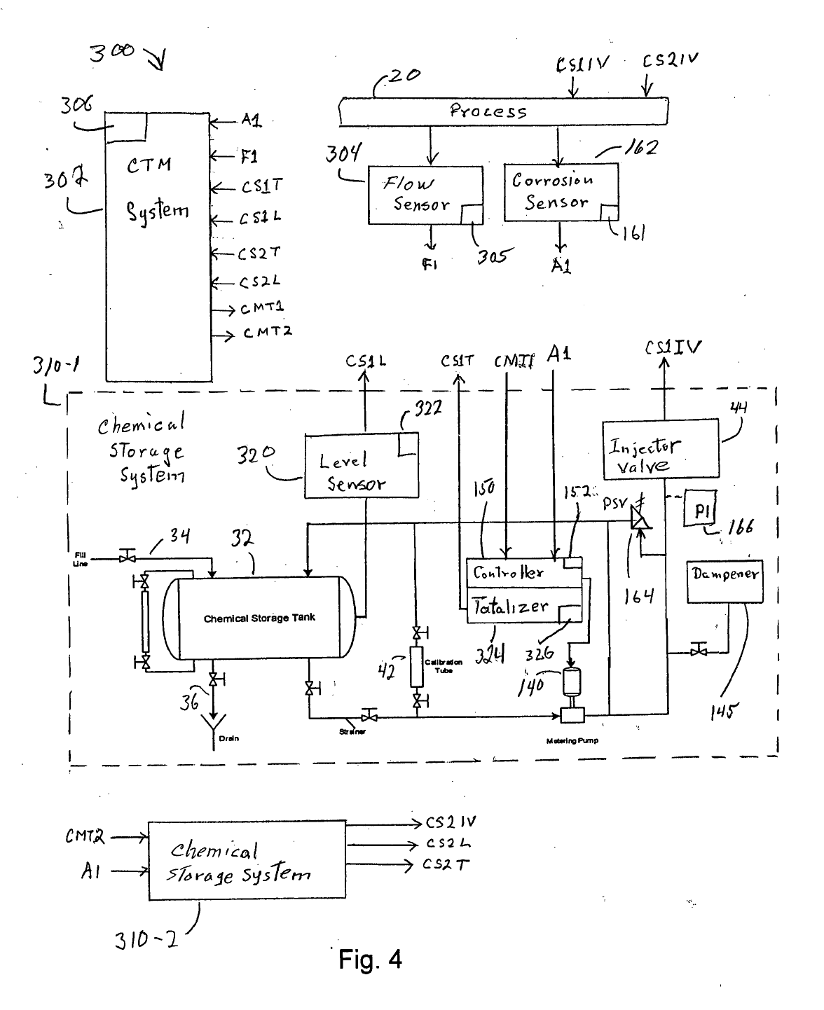

Referring to FIG. 4, a chemical treatment system 300 of the present invention is disposed to control chemical treatment of a process 20. Chemical treatment system 300 includes components that are the same as components included in the systems of FIGS. 1 and 2 and that bear like reference numerals.

Chemical treatment system 300 comprises a chemical treatment management (CTM) system 302 that manages chemical treatment dosages from one or more chemical storage systems, shown, by way of example, as two chemical storage systems 310-1 and 310-2. It will be apparent to those skilled in the art that other embodiments may comprise more or less than two chemical storage systems. Chemical storage systems 310-1 and 310-2 are substantially identical so that only chemical storage system 310-1 will be described in detail.

CTM system 302 controls chemical treatment dosages in real time based on signals that are functions of one or more conditions (pressure, temperature, level, flow, pH, etc.) of process 20. These signals are provided by sensors associated with process 20. In the embodiment of FIG. 4, a corrosion sensor 162 and flow sensor 304 are provided by way of example. Corrosion sensor 162 is disposed to sense a corrosion condition of process 20 and provide an output signal A1. Flow sensor 304, is disposed to sense a flow condition of process 20. Flow sensor 304 provides an output signal F1 that is a function of the flow condition. Preferably, corrosion sensor 162 and flow sensor 304 comprise wireless transmitters 161 and 305 to transmit signals A1 and F1, respectively. CTM system 302 comprises a wireless transceiver 306 that transmits and receives wireless signals, such as output signals A1 and F1, as well as signals to and from chemical storage systems 310-1 and 310-2 that are described hereinafter.

Corrosion sensor 162 provides several types of process variables. One process variable indicates corrosion rate and another indicates pitting. CTM system 302 uses the process variables to determine when pitting is occurring and command chemical storage systems 310-1 and/or 310-2 to provide a dosage of a chemical (or chemicals) that inhibits both pitting and fast corrosion rates to be injected into the system. When normal corrosion is detected, CTM system 302 may direct the process control system to use a slower reacting inhibitor or less inhibitor. Thus, CTM system 302 can be used to enable delivery (and/or dosage control) of the best chemical suited to the task and turn off other chemicals.

CTM system 302 manages the chemical treatment dosages to provide a control output signal to a multi-variable controller or to a single input single output (SISO) controller/control loop in a chemical storage system. In some embodiments, CTM system 302 controls the treatment dosage provided by a single chemical storage system and in other embodiments controls treatment dosages provided by a plurality of chemical storage systems as shown in FIG. 4.

Chemical storage system 310-1 differs from the chemical treatment system of FIG. 2 in the following manner. A level sensor 320 provides an output signal CS1L that is a function of the chemical level in chemical storage tank 32. Level sensor 320 comprises a wireless transmitter 322 that transmits output signal CS1L to CTM system 302. A totalizer 324 is provided in association with controller 150. Totalizer 324 correlates dosage treatment against a parameter of output signal A1, e.g., corrosion and/or pitting data and provides an output signal CS1T indicative of the correlation. Totalizer 324 comprises a wireless transmitter 326 that transmits output signal CS1T to CTM system 302.

CTM system 302 uses the level signal CS1L and the correlation signal CS1T to make dosage calculations, calculate a predicted chemical level in tank 32, and compare the actual level with the calculated level. CTM system 302 uses this comparison to determine if tank leakage is occurring that warrants maintenance and can also be used to determine if the tank is being accidentally drained.

Output signal A1 of corrosion sensor 162 is provided to both controller 150 of chemical storage system 310-1 and to CTM system 302 so that controller 150 still operates as an independent loop if CTM system 302 (or other advanced supervisory control application) sheds supervisory control or in the case that the supervisory control is turned off. In these cases, the dosage control would revert to operation as described above for system 130 of FIG. 2. CTM system 302 correlates corrosion with the process operator conditions, product throughput, and makes financial calculations with which to provide optimization control outputs, provides alarms and alert messages, and allows corrosion vs. dosage to be correlated and graphically represented. Additionally, CTM system 302 uses the process variables of signal A1 to determine if process 20 is undergoing normal corrosion or more highly detrimental pitting and to turn on the appropriate chemical storage system 310-1 or 310-2 to deal with the environment of process 20.

Flow sensor 304 provides feed forward information to a supervisory controller (e.g., Profit Suite, DMC or Multivariable Controller) or to CTM system 302 so that controller 150 can be controlled to react to process flow changes instead of waiting for the corrosion changes to show up in the feedback signal A1. Generally, flow changes in process 20 can be correlated to the corrosion rates in the equipment. It can be more efficient to cause a preemptive dosage change to react to these process flow changes. In alternate embodiments controller 150 can be provided with functionality to accept a disturbance variable like the process flow rate or flow signal F1 so that controller 150 can directly use signal F1 instead of requiring supervisory control by CTM system 302 (or the aforementioned supervisory controller).

CTM system 302 processes signals A1, F1, CS1T and CS1L to provide a command signal CMT1 to controller 150 of chemical storage system 310-1. Chemical storage system 310-1 responds with a dosage treatment CS1IV issued from injector valve 44 to process 20.

Chemical storage system 310-2 similarly receives input signals CMT2 and A1 and provides output signals CS2L and CS2T. CTM system 302 processes signals A1, F1, CS2T and CS2L to provide command signal CMT2 to controller 150 of chemical storage system 310-2. Chemical storage system 310-2 responds with a dosage treatment CS2IV issued from its respective injector valve to process 20.

CTM system 302 additionally provides users the ability to generate reports, graphs, alerts, maintenance work orders, chemical refill orders, and control as follows:
1. Report on the chemical usage and effectiveness to determine the degree of a manufacturer's chemical agent effectiveness or even if there is any affect at all on the process and/or corrosion, pitting, foaming, pH, etc.
2. Provide graph of chemical treatment agent vs. corrosion (and/or pitting, and/or pH, and/or foaming, and/or production rate, and/or production quality, and or cost of production, and/or other key process indicators).
3. Provide Alerts/Alarms to the process control system to alert process operators of pitting events or high corrosion events, or impending corrosion events that require operator intervention.
4. Provide Alerts to the maintenance staff to fix problems (e.g. leaking chemical tank, re-calibration schedule, maintenance schedule, etc.)

CTM system 302 manages multiple chemical storage systems 310-1 and 310-2. One application is that CTM system 302 operates to switch between a corrosion inhibitor (in storage tank 32 of chemical storage system 310-1) and a pitting inhibitor (in the storage tank of chemical treatment system 310-2) based on feedback from process 20. CTM system 302 uses both the A1 and F1 signals to formulate control commands to meter pump 140 of chemical storage system 310-1 and the corresponding metering pump 140 of chemical system 310-2. However, when supervisory control mode sheds to independent level-1 control the AI signal process variable pitting factor is used to control the metering pump of chemical storage system 310-2 and the AI signal process variable corrosion factor is used to control metering pump 140 of chemical storage system 310-1.

Furthermore, CTM system 302 manages re-ordering chemicals for all chemical storage systems, provide alerts based on leakage or other abnormal situation, determines the effectiveness of the treatment chemicals in achieving their designed affect to the process, as well as determines financial impact of using the chemical treatments (including cost of treatment, cost to produce, product quality, equipment damage, equipment lifespan and equipment maintenance cost.

In addition to the aforementioned sensing devices, CTM system 302 may also have various pressure, temperature, pH, and other inputs that it can use to predict affects on corrosion, pitting, foaming, and other process environmental conditions and to predict the effectiveness of chemical treatment agents correlated against the process environment.

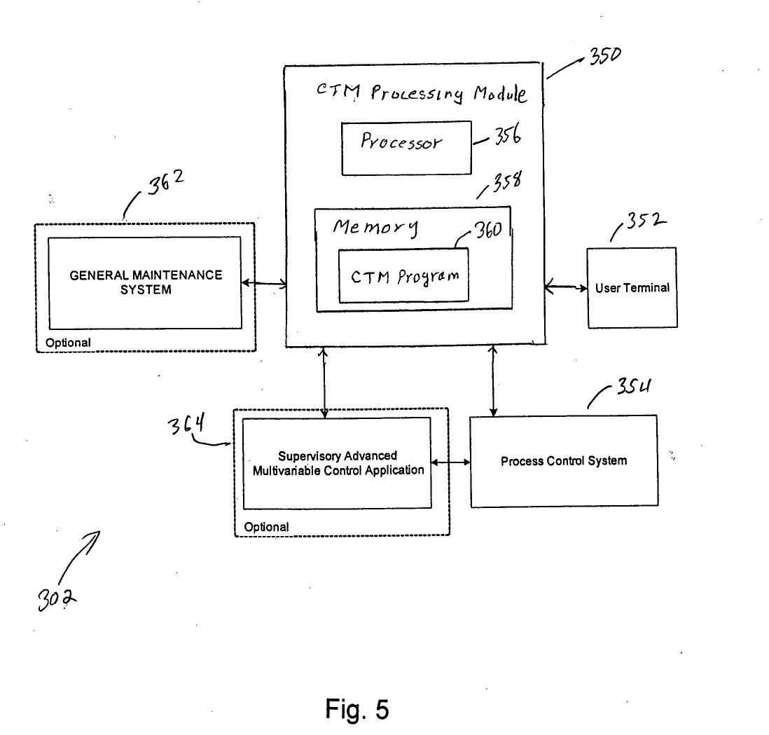

Referring to FIG. 5, CTM system 302 comprises a CTM processing module 350, a user terminal 352 and a process control system 354. Process control system 354 provides an interface to the sensors 162 and 304 and the chemical storage systems 310-1 and 310-2. That is, process control system 354 receives the signals A1, F1, CS1T, CS1L, CS2T and CS2L and converts them to a format that can be processed by CTM processing module 350. Process control system 354 also converts the command signals from CTM processing module 350 to signals CMT1 and CMT2 in a format usable by controllers 150 of chemical storage systems 310-1 and 310-2.

CTM processing module 350 comprises a processor 356 and a memory 358. A CTM program 360 is stored in memory 360. Memory 358 and processor 356 have sufficient capacity to run CTM program 360. CTM processing module 350 is interconnected in a network (wired and/or wireless) with various output devices to which it provides output reports, alerts, graphs, historical data and correlation information. A user can use user terminal 352 for user configuration of the CMT system 302 and general interface. The user terminal 352 may suitably be a personal computer platform. CTM processing module 350 can optionally communicate with a general maintenance management system 362 and optionally communicate with an advanced control application 364 (or applications) to provide optimized control to process 20 as well as optimized management of the chemical tanks and treatment system itself.

CTM processing module 350 communicates with process control system 354 to provide cascade or supervisory control over the level-1 loops that accomplish chemical dosage control. Preferably, controllers 150 of chemical storage system 310-1 and 310-2 are model based controllers, such as Profit Loop controllers instead of traditional PID loop controllers. Model-based loop controllers provide better control and response than PID loop controllers, are more robust to process upsets and changes in operating conditions, and more closely follow/compensate for the actual corrosion response curve.

CTM program 360 takes in multiple variables including process operating settings, process environmental conditions, production rates, raw material cost, product quality measures (and/or rejection rates), chemical indicators, and other user chosen key process indicators and analyzes these inputs to produce as outputs items such as the items in the following list (the list contains a representative list but not a fully comprehensive list):
1. Report on the chemical usage and effectiveness to determine the degree of a manufacturer's chemical agent effectiveness or even if there is any effect at all on the process and/or corrosion, pitting, foaming, pH, etc.
2. Provide graphs of chemical treatment agent vs. corrosion (and/or pitting, and/or pH, and/or foaming, and/or production rate, and/or production quality, and or cost of production, and/or other key process indicators).
3. Provide alerts/alarms to the process control system to alert process Operators.
4. Provide alerts to the maintenance staff to fix problems (e.g. leaking chemical tank, re-calibration schedule, maintenance schedule, etc.)
5. Control output to a multi-variable controller or to a single input single output (SISO) controller/control loop.
6. Provide orders or order requests for chemical agents to be re-ordered
7. Include financial indicators in the determination of the best chemical to use for treating the process control system as well as available inventory of chemicals.
8. Include environmental impact factors in the determination of the best chemical to use for treating the process control system as well as available inventory of chemicals. Also, use environmental factors in determining the best recommended course of action in alerts to the process operator and maintenance staff.
9. Provide alarm to the process control system if severe leak or problem exists so that the process operator can take action.
10. Provide action recommendation to the process control operator base on an inferred event and the best corrective action based on the available treatment chemicals and systems.

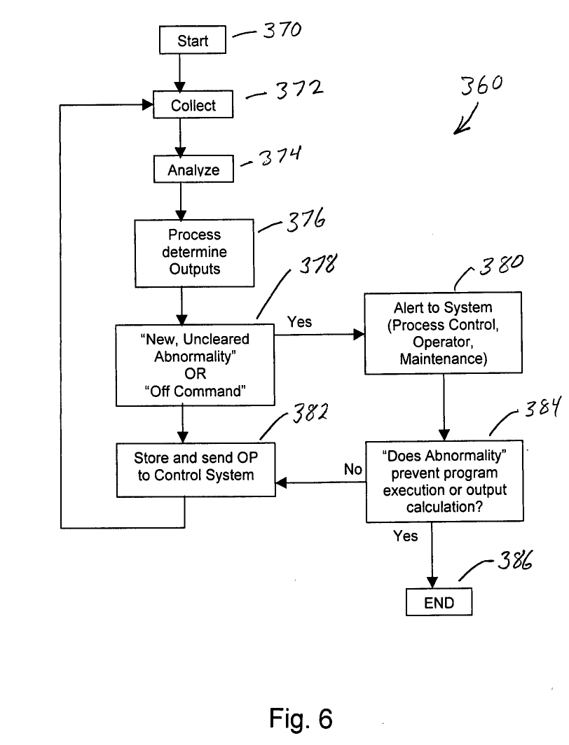

Referring to FIG. 6, CMT program 360 moves from a start box 370 to step 372 to collect data A1 and F1 from corrosion sensor 161 and flow sensor 320, signals CS1L and CS1T from chemical storage system 310-1 and signals CS2L and CS2T from chemical storage system 310-2 as well as other data, such as financial data from sources, not shown in the drawings. At step 374 the collected data is analyzed. At step 376, the analyzed data is processed and correlated with performance characteristics to determine an output action. At step 378 it is determined if abnormalities, such as a new or uncleared abnormality or an off command, are present. If so, step 380 provides alerts to a process control system operator and/or to maintenance system 362 and control returns to step 372. If not, step 382 stores the data and send output action. For example, command signals CMT1 and/or CMT2 are sent to process control system 354 for signal conditioning before relay to chemical storage systems 310-1 and/or 310-2. Other output action can be sent to a graphical interface, user terminal 352, maintenance system 362, and/or supervisory advanced multivariable control application 364. CMT program 360 then loops back to step 372. Step 384 determines if the abnormality prevents execution of CMT program 360. If so, CMT program is exited at step 386. If not, step 392 is performed.

The present invention having been thus described with particular reference to the preferred forms thereof, it will be obvious that various changes and modifications may be made therein without departing from the spirit and scope of the present invention as defined in the appended claims.

What is claimed is:

1. A chemical treatment system that injects a chemical solution into a process for corrective action of a condition of said process, said system comprising:
a chemical storage system that comprises a chemical storage tank containing a chemical solution; and
a chemical treatment management system that receives notice of said condition and provides a command for said corrective action to said chemical storage system that responds to provide a dosage of said chemical solution to said process.

2. The chemical treatment system of claim 1, wherein said condition comprises one or more variables of corrosion.

3. The chemical treatment system of claim 1, wherein said chemical treatment management system receives said notice and sends said command via wireless communication.

4. The chemical treatment system of claim 1, wherein said chemical treatment management system receives a notice of a level of said chemical solution in said chemical storage tank, and wherein said chemical treatment management system provides an alert output when said level is unexpectedly low.

5. The chemical treatment system of claim 1, wherein said condition is a first condition of a plurality of conditions associated with said process, and wherein said chemical treatment management system determines said dosage based additionally on a second condition of said plurality of conditions.

6. The chemical treatment system of claim 5, wherein said second condition is a member of the group consisting of: operating settings of said process, process environmental conditions, production rates, raw material cost, product quality measures, rejection rates, chemical indicators, other user chosen key process indicators and any combination thereof.

7. The chemical treatment system of claim 1, wherein said condition is a member of the group consisting of: corrosion, flow, pressure, temperature, pH, and other inputs for prediction of effects on corrosion, pitting, foaming, and other process environmental conditions.

8. The chemical treatment system of claim 1, wherein said notice of said condition is received by both said chemical storage system and said chemical treatment management system, and wherein said chemical treatment management system determines whether said command is provided to said chemical storage system, and wherein if said command is not provided, said chemical storage system responds to said notice to provide said dosage of said chemical solution to said process.

9. The chemical treatment system of claim 1, wherein said chemical treatment management system produces as outputs one or more of the following items:
a report on usage and effectiveness of the chemical solution on said process and/or said condition,
a graph of chemical treatment agent vs. said condition, and/or production quality, and or cost of production, and/or other key process indicators,
an alert/alarm to the process control system to alert process operators of pitting events or high corrosion events, or impending corrosion events that require operator intervention,
an order or order request for chemical agents to be re-ordered for said chemical solution,
a determination of the best chemical to use for treating said condition of said process based on financial indicators and/or environmental impact factors as well as available inventory of chemicals,
a determination of a best recommended course of action for alerts/alarms to said operator of said process based on environmental factors, or
a recommended course of action based on an inferred event of said process and a best corrective action based on available treatment chemicals.

10. The chemical treatment system of claim 9, wherein said alert/alarm comprises a notification of the existence of a leak in said chemical storage tank.

11. The chemical treatment system of claim 1, wherein said chemical storage system is a first chemical storage system, and further comprising a second chemical storage system also comprising a chemical tank containing a chemical solution, and wherein said chemical treatment management system selectively enables said first and second chemical storage systems to provide dosages of their respective chemical solutions to said process.

12. The chemical treatment system of claim 11, wherein said chemical solution of said second chemical storage system also treats said condition or treats another condition of said process.

13. The chemical treatment system of claim 1, wherein said chemical treatment management system comprises a processing module and a process control system that receives said notice of said condition and transmits said command to said chemical storage system, and wherein said processing module determines said dosage of said chemical solution based on said notice for inclusion in said command.

14. The chemical treatment system of claim 13, wherein said processing module comprises a program that determines said command.

15. The chemical treatment system of claim 14, wherein said program determines said command based on a plurality of conditions.

16. A method of injecting a chemical solution into a process for corrective action of a condition of said process, said method comprising:
providing a dosage of said chemical solution to said process; and
controlling said providing step with a chemical treatment management system based on a notification of said condition and at least one other condition associated with said process.

17. The method of claim 16, wherein said condition comprises one or more variables of corrosion.

18. The method of claim 16, wherein said condition is a first condition of a plurality of conditions associated with said process, and wherein said chemical treatment management system determines said dosage based additionally on a second condition of said plurality of conditions.

19. The method of claim 16, wherein said chemical solution is a first chemical solution that is contained in a first chemical storage tank, wherein a second chemical solution is contained in a second chemical storage tank, and wherein said chemical treatment management system selectively controls providing dosages of said first and second chemical solutions from said first and second chemical storage tanks, respectively, to said process for said corrective action.

20. The method of claim 19, wherein said chemical solution of said second chemical storage tank also treats said condition or treats another condition of said process.

21. The method of claim 16, wherein said chemical solution is contained in a chemical storage tank, wherein said chemical treatment management system receives a notice of a level of said chemical solution in said chemical storage tank, and wherein said chemical treatment management system provides an alert output when said level is unexpectedly low.
